(19) United States
(12) Patent Application Publication
(10) Pub. No.: US 2018/0297256 A1
(43) Pub. Date: Oct. 18, 2018

(54) Process for producing an encoder

(71) Applicant: Schaeffler Technologies AG & Co. KG, Herzogenaurach (DE)

(72) Inventors: Stefan Kurzbeck, Nürnberg (DE); Patrick Schmitt, Gerolzhofen (DE); Christian Mock, Schweinfurt (DE)

(73) Assignee: Schaeffler Technologies AG & Co. KG, Herzogenaurach (DE)

(21) Appl. No.: 15/776,414

(22) PCT Filed: Sep. 26, 2016
(86) PCT No.: PCT/DE2016/200446

§ 371 Date: May 16, 2018

(30) Foreign Application Priority Data
Dec. 2, 2015 (DE) 10 2015 223 978.0

(51) Int. Cl. B29C 45/16; B29C 45/56; B29C 45/14; B05D 1/24

(52) U.S. Cl. CPC B29C 45/1671; B29C 45/561; B29C 45/14311; B29K 2077/00; B29C 45/14786; B29K 2995/0008; B05D 1/24

(57) ABSTRACT

Methods for producing an encoder are disclosed. In one example, a method may include introducing an insert part into a mold, wherein the insert part is a support part, a metal foil, or a metal-coated foil. A first component may be injected into the mold, wherein the first component is an adhesion promoter. The first component is then cooled, wherein the first component joins with the insert part. A second component is injected into the mold, wherein the second component includes a material which comprises polyamide 6, polyamide 12, or polyphenylene sulfide and at least one magnetic filler. The second component is then cooled, wherein the second component joins with the first component and forms the encoder.

### CROSS-REFERENCE TO RELATED APPLICATIONS

This application is the U.S. National Phase of PCT Appln. No. PCT/DE2016/200446 filed Sep. 26, 2016, which claims priority to DE 10 2015 223 978.0 filed Dec. 2, 2015, the entire disclosures of which are incorporated by reference herein.

### TECHNICAL FIELD

The disclosure relates to a number of methods for producing an encoder, e.g., for bearing units.

### BACKGROUND

Methods for producing encoders for bearing units have been known for a long time. It is known practice, for example, to provide a one-component injection molding process wherein a melt composed of a thermoplastic and a magnetic filler is used for an encoder.

Magnetic encoders and magnetic field measurement sensors are used for the contactless detection of relative motions between stationary and moving machine parts. The encoder comprises a magnetic component, more particularly a magnet, which along the direction of motion is provided with one or more alternating magnetizations, e.g., north-south pole.

The magnetic field measurement sensor detects this pole switch and converts it into an electrical signal which is useful for a computer-assisted further-processing operation. The magnetic component of the encoder is generally fastened on a metallic support, in order to allow the encoder to be mounted easily.

### SUMMARY

The technical problem addressed is therefore that of providing alternative methods for producing encoders for bearing units.

A number of alternative methods are presented for producing an encoder, such as a two-component injection molding process, an in-mold foil coating process, an injection-compression molding process, and a fluidized sintering process.

The problem is solved in accordance with an embodiment of the disclosure in particular by a method for producing an encoder for bearing units, comprising the following steps:

introducing an insert part into a mold, where the insert part is a support part, a metal foil, or a metal-coated foil,

injecting a first component into the mold, where the first component is an adhesion promoter,

cooling the first component, where the first component joins with the insert part,

injecting a second component into the mold, where the second component includes a material which comprises polyamide 6, polyamide 12 or polyphenylene sulfide and at least one magnetic filler, and

cooling the second component, where the second component joins with the first component and in this way the encoder is formed.

The bearing unit may be designed as a wheel bearing for commercial vehicles, trucks, automobiles, etc.

In one embodiment according to the disclosure, the method comprises the following steps of:

injecting the first component using a first device and

injecting the second component using a second device.

Further, the problem is solved in accordance with the disclosure in particular by a method for producing an encoder for bearing units, comprising the following steps:

introducing an insert part into a mold, where the insert part is a support part, a metal foil, or a metal-coated foil,

injecting a melt into the mold, where the melt includes a material which comprises polyamide 6, polyamide 12 or polyphenylene sulfide and at least one magnetic filler, and

compressing the melt, where the melt joins with the insert part to form the encoder on cooling of the melt.

In a further embodiment according to the disclosure, the method comprises the further step of:

injecting the melt using a first device.

In a further embodiment according to the disclosure, the method comprises the further steps of:

injecting the melt into the mold, where the mold is not fully closed, and so an embossing gap is formed in the mold, and

generating an action of pressure on the mold to close the mold until the embossing gap is eliminated.

Further, the problem is solved in accordance with the disclosure in particular by a method for producing an encoder for bearing units, comprising the following steps:

introducing an insert part into a mold, where the insert part is a support part, a metal foil, or a metal-coated foil,

injecting a melt using a first device into the mold, where the melt includes a material which comprises polyamide 6, polyamide 12 or polyphenylene sulfide and at least one magnetic filler, and

compressing the melt, where the melt joins with the insert part to form the encoder on cooling of the melt.

In a further embodiment according to the disclosure, the method comprises the further step of:

injecting the melt using a first device.

Further, the problem is solved in accordance with the disclosure in particular by a method for producing an encoder for bearing units, comprising the following steps:

heating a support part,

introducing the support part into a bath of plastics powder, where the plastics powder comprises polyamide 6, polyamide 12 or polyphenylene sulfide and at least one magnetic filler and where the plastics powder is fluidized by an airstream, and

impinging the magnetic particles onto the support part, with the plastics powder remaining adhering on the support part.

The encoder is preferably magnetized in one method step, meaning that magnetic coding is applied. With preference the encoder is magnetized in a final method step.

The encoder is produced using polyamide 6 (PA6 for short), polyamide 12 (PA12 for short) or polyphenylene sulfide (PPS for short), since among the plastics materials, these exhibit high elongation and therefore a relatively high flexibility even with a high filler content. PA12, moreover, is notable for its high chemical resistance and good sliding friction characteristics.

The filler may comprise hard ferrites, iron, iron-containing compounds, or elements of the rare earths, or a combination of these fillers. Accordingly the encoder may have a high resistance toward abrasion. The rare earths are preferably neodymium or samarium.

The fraction of the filler may be 70 to 95 wt % of the material. Accordingly the resistance toward abrasion is additionally increased.

The encoder may comprise not only the support part but also a magnet part. A metal foil, a metal-coated foil, or a metal coating is preferably disposed or attached on the magnet part, or an adhesion promoter is disposed between the metal foil, the metal-coated foil or the metal coating and the magnet part. The adhesion promoter may be a primer.

The provision of these components highlights possibilities for differently designing the encoder and adapting it to the particular installation scenario.

The encoder may comprise a support part, with the magnet part being applied on the support part or with an adhesion promoter being disposed between the support part and the magnet part.

By the provision of the support part, the magnet part can be easily mounted on the bearing unit. The support part is preferably made of metal, being for example a metal support sheet or a metal support. The metal support sheet is preferably an insert part.

Given sufficient adhesiveness, PA6, PA12 or PPS can be injection-molded directly onto the support part in a two-component injection molding process. A higher adhesive strength may be acquired by an adhesion promoter. An adhesion promoter may be a silane adhesion promoter in accordance with EP 1707923 B1.

As a pretreatment, e.g., activation, or primer layer it is possible to apply phosphating; other pretreatments such as roughening, pickling, electrical discharges may be beneficial to the adhesion. It is possible, moreover, to employ primers based on epoxy resin, on phenolic resin, on polyurethane, and on acrylate. For attaching PA6, PA12 or PPS by adhesive bonding to a support part, preference is given to using a two-component system, since solvent-based adhesives cannot be employed. Likewise conceivable here are two-component epoxy resins, phenolic resins, polyurethane resins or acrylate resins. Preference is given to using layer systems composed of a plurality of different primers for promoting adhesion.

It is also possible for joining with the metal support sheet to be accomplished via snap connections, since PA6, PA12 or PPS, even in filled form, has high elongation. The metal support sheet may be serrated on its outer edge or has notches allowing the plastic ring to be attached form-fittingly and securely with respect to slippage.

Primers which can be used are, preferably, common resin systems, which produce a connection preferably by adhesion, adsorption or a chemical bond via COOH, OH or NH2 groups. Another possibility is to use hybrid polymers having functional groups which generate a chemical bond.

Furthermore, PA6, PA12 or PPS displays high adhesion to metals, even without primer. To promote adhesion between magnet part and support part, it is possible with preference to use a primer layer of hybrid polymers, e.g., Ormocers™, on the support part, which can be injection-molded on directly or onto which can be shapingly pressed the softened/heated plastics compound.

As a result of the high extensibility it is also possible for the plastic to be joined to the metal support sheet via snap connections (e.g., expanding button or rounded catch spring). The plastic can preferably be applied directly in an injection molding or transfer molding process. In this context, PA6, PA12 or PPS proves to exhibit very little warping, hence ensuring high dimensional integrity. This is an advantage in particular since from the encoders, as magnetic components, segmented signals are tapped, and can be read more clearly when there is little warpage.

PA6, PA12 or PPS have the advantage, moreover, that it crystallizes, or solidifies, very rapidly, allowing short cycle times to be realized; this is also advantageous in relation to preserving the environment. A further advantage is that the excellent chemical resistance of the material allows the range of lubricants to be extended.

The encoder may have a construction different from that which has been customary to date, namely magnetically filled plastic with primer and with metal support sheet. The encoder may be produced by a method wherein the magnet part, filled with magnetic particles, is coated with a metallic layer in appropriate thickness. In this case, the usual support part for magnetic gathering is eschewed or replaced by the coating.

The metallic layer can be applied in a PVD process (physical vapor deposition process), CVD process (chemical vapor deposition process), by electroplating or vapor deposition (e.g., electron beam, sputtering, etc.). In this case it may be necessary to ensure that the substrate—that is, the plastic of the support part—is not damaged, partly melted or fully melted, as a result of high temperature loads. The CVD layer may be constructed, for example, from iron pentacarbonyl with or without carrier gas (e.g., H2). The layer applied may then be additionally sealed with a corrosion control layer for improved durability.

A further variant involves applying the magnet part to a foil. This may be accomplished by the technique of in-mold foil coating. The foil itself may include a metallic material and may therefore allow for magnetic gathering, hence enabling an increase to be achieved in the attainable strength of the magnetization. The foil may preferably have been coated with a primer. With further preference, the foil in this case may be drawn as continuous product into the injection molding machine and processed by the process of in-mold foil coating; it is, however, also possible to cut or to punch the foil pieces into shape beforehand and to use them as an insert part.

The shaping of the foil takes place preferably in an upstream machining step, which is also possible in the injection mold. With particular preference a thin adhesion promoter foil or a metal-coated foil or adhesion promoter foil is coated with a compound by in-mold coating. The plastic/adhesion promoter foil assembly can then be applied, preferably in a further method step, to the support part (metal insert) or to a metal foil.

A further possibility involves coating the metal support sheet with the magnetically filled plastic. This can be realized preferably in a fluidized sintering process, in which a preheated support part is introduced into a bath of plastics powder, e.g. a compound and magnetic particles. The plastics powder is preferably fluidized by an airstream emerging from nozzles, with the particles remaining adhering on impingement onto the hot component. The attainable layer thicknesses are around 150 to 1000 μm; the layer thickness required for a good signal is around 700 μm.

It is also possible for the compound to be applied in a wet-chemical procedure, in other words as particles in solution; for that purpose, the support part or the metal foil may be coated after a primer has been applied beforehand. Furthermore, the process of powder coating with the filler/plastic compound powder may be employed.

A further possibility for positioning the material PA6, PA12 or PPS with magnetic particles (PK-MP for short) in/on the bearing may involve the compound being adhered directly onto the outer ring of the bearing with the support part. It is possible, moreover, for the compound to be injection-molded directly onto the outer ring.

A further processing option involves the PK-MP material being processed in a two-component injection molding process with or without metal support sheet. In the case of processing with metal support sheet, this sheet is preferably inserted into the injection molding machine; the first component in this case may be, for example, a primer plastic or primer elastomer (e.g., a thermoplastic elastomer), or a primer in general, and the second component may be the material. In the case of processing without metal support sheet, the first component may preferably be the material (e.g., PK-MP). The second component, which is preferably a compound of PA6, PA12 or PPS filled with a shielding filler, e.g., a highly filled compound with carbon fibers or an aluminum-filled compound, may be injection-molded onto the first component.

A further possibility is to injection-mold a braid of fibers (carbon fibers or other shielding fibers) with the material; in other words, the fiber braid can be intrinsically reinforced by a thermoplastic or thermoset. Following insertion of the braid or of a reinforced braid disk into the injection molding machine, the PA6, PA12 or PPS material is preferably injection-molded on. This may be done with or without primer.

### BRIEF DESCRIPTION OF THE DRAWINGS

The disclosure is now illustrated by way of example using figures, wherein:

FIG. 1a to 1d show an example production method for an encoder,

FIGS. 2a to 2d show an alternative example production method for an encoder, and

FIGS. 3a to 3e show a further alternative example production method for an encoder.

### DETAILED DESCRIPTION

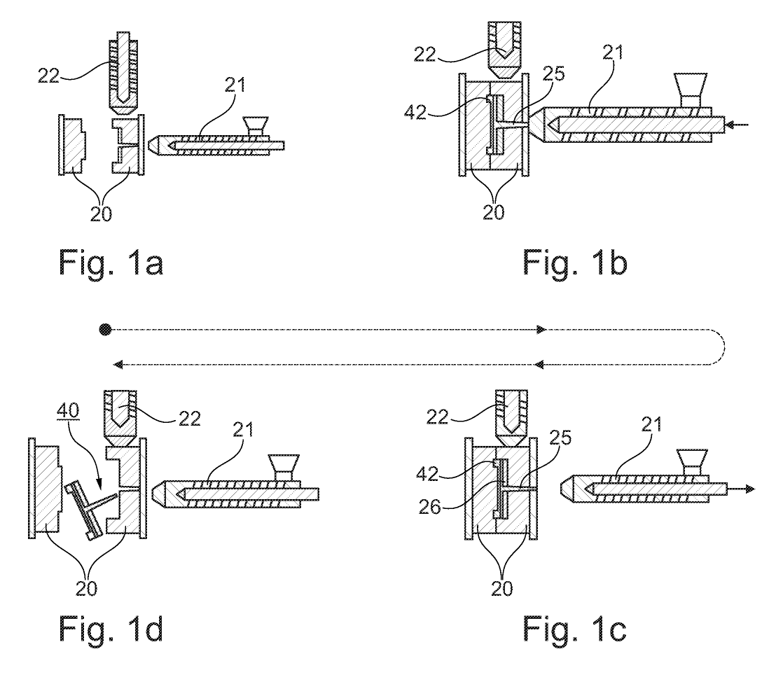

FIG. 1a to FIG. 3e show example embodiments. The disclosure is not confined to these example embodiments. The encoders produced by the methods may all have a magnet part including a material which comprises polyamide 6, polyamide 12 or polyphenylene sulfide and at least one magnetic filler.

FIG. 1a to 1d show a first production method for an encoder 40, according to an embodiment. The production method is a two-component injection molding process.

The first method for producing the encoder 40 for bearing units comprises the following steps:

introducing insert part into a mold 20, with the insert part being a support part 42,

injecting a first component 25 into the mold 20, where the first component 25 is an adhesion promoter,

cooling the first component 25, where the first component 25 joins with the support part 42,

injecting a second component 26 into the mold 20, where the second component 26 includes a material which comprises polyamide 6, polyamide 12 or polyphenylene sulfide and at least one magnetic filler, and

cooling the second component 26, where the second component 26 joins with the first component 25 and in this way the encoder 40 is formed.

The support part 42 here may have been pretreated mechanically or by phosphating. The first component 25 and the second component 26 are injected under the action of pressure. Both components are flowable, and may be melts. After cooling has taken place, the encoder 40 can be ejected or removed from the mold 20. In this case the mold 20, the first device 21, and the second device 22 are parts of an injection molding machine.

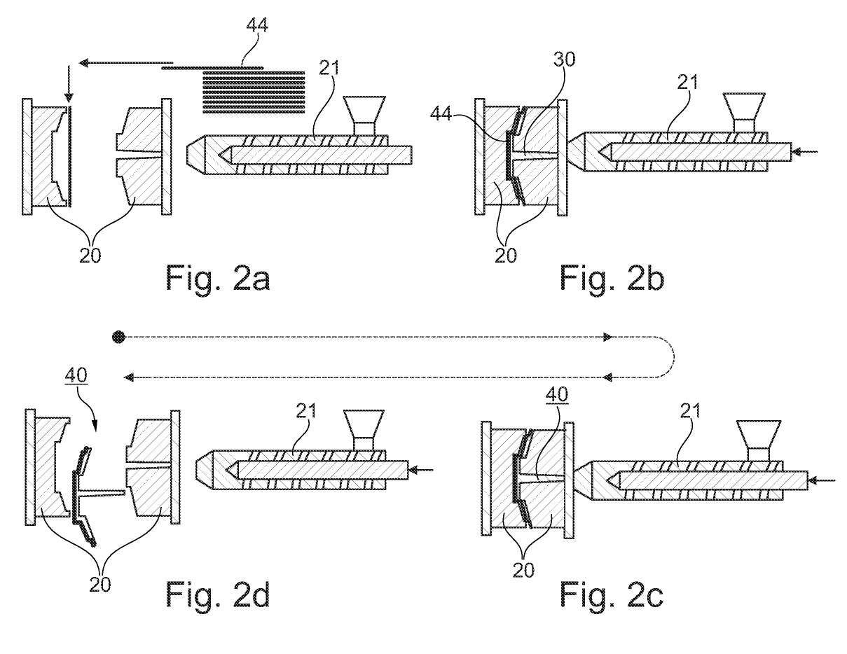

FIGS. 2a to 2d show a second production method for an encoder 40, according to an embodiment. The production method is an in-mold foil coating process.

The second method for producing the encoder 40 for bearing units comprises the following steps:

introducing an insert part into a mold 20, with the insert part being a metal foil 44,

injecting a melt 30 into the mold 20, where the melt 30 includes a material which comprises polyamide 6, polyamide 12 or polyphenylene sulfide and at least one magnetic filler, and

compressing the melt 30, where the melt 30 joins with the metal foil 44 to form the encoder 40 on cooling of the melt 30.

Furthermore, an adhesion promoter may also have been provided on the metal foil 44. When the mold 20 is pressed together, the metal foil 44 inserted into the mold 20 is embossed in accordance with the shape of the mold 20. The melt 30 is injected under the action of pressure. After cooling has taken place, the encoder 40 can be ejected or removed from the mold 20. In this case the mold 20, the first device 21, and the second device 22 are parts of an injection molding machine.

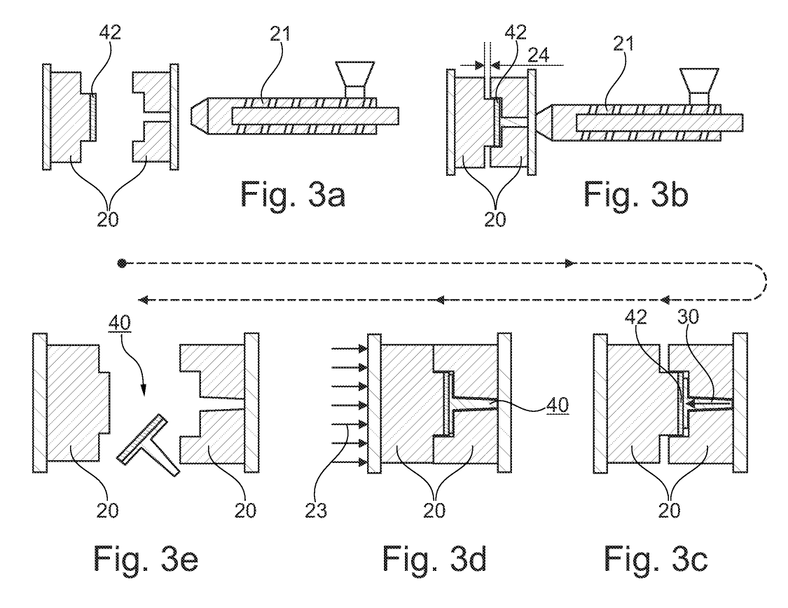

FIGS. 3a to 3e show a third production method for an encoder 40, according to an embodiment. The production method is an injection-compression molding process.

The third method for producing the encoder 40 for bearing units comprises the following steps:

introducing an insert part into a mold 20, where the insert part is a support part 42,

injecting a melt 30 using a first device 21 into the mold 20, where the melt 30 includes a material which comprises polyamide 6, polyamide 12 or polyphenylene sulfide and at least one magnetic filler, and

compressing the melt 30, where the melt 30 joins with the support part 42 to form the encoder 40 on cooling of the melt 30.

The support part 42 here may have been pretreated mechanically or by phosphating. Furthermore, an adhesion promoter may also have been provided on the support part 42. On injection of the melt 30 into the mold 20, the mold 20 is not fully closed, and so on embossing gap 24 is able to form in the mold 20. As a result of an action of pressure, 23, on the mold 20, the melt 30 is compressed in the mold 20. As soon as the mold 20 is closed, the embossing gap 24 no longer exists. After cooling has taken place, the encoder 40 can be ejected or removed from the mold 20. In this case the mold 20, the first device 21, and the second device 22 are parts of an injection machine.

A fourth production method, but one which is not shown, is a fluidized sintering process.

The fourth method for producing the encoder 40 for bearing units comprises the following steps:

heating a support part,

introducing the support part into a bath of plastics powder, where the plastics powder comprises polyamide 6, polyamide 12 or polyphenylene sulfide and at least one magnetic filler, more particularly magnetic particles, and where the plastics powder is fluidized by an airstream, and

impinging the magnetic particles onto the support part, with the plastics powder remaining adhering on the support part.

Furthermore, there are also other methods envisaged for producing an encoder for bearing units. Processes include the following:

PVD processes (physical vapor deposition processes),

CVD processes (chemical vapor deposition processes),

electroplating or vapor deposition (e.g., electron beam, sputtering, etc.).

The provision of these methods highlights various possibilities of producing an encoder for bearing units.

### LIST OF REFERENCE NUMERALS

20 mold

21 device

22 device

33 action of pressure

24 embossing gap

25 component

26 component

30 melt

40 encoder

42 support part

44 metal foil

1. A method for producing an encoder for bearing units, comprising the following steps:
introducing an insert part into a mold, wherein the insert part is a support part, a metal foil, or a metal-coated foil,
injecting a first component into the mold, wherein the first component is an adhesion promoter,
cooling the first component, wherein the first component joins with the insert part,
injecting a second component into the mold, wherein the second component includes a material which comprises polyamide 6, polyamide 12, or polyphenylene sulfide and at least one magnetic filler, and
cooling the second component, wherein the second component joins with the first component and forms the encoder.

2. The method as claimed in claim 1, wherein:
injecting the first component is performed by a first device and
injecting the second component is performed by a second device.

3. A method for producing an encoder for bearing units, comprising the following steps:
introducing an insert part into a mold, wherein the insert part is a support part, a metal foil, or a metal-coated foil,
injecting a melt into the mold, wherein the melt includes a material which comprises polyamide 6, polyamide 12 or polyphenylene sulfide and at least one magnetic filler, and
compressing the melt, wherein the melt joins with the insert part to form the encoder on cooling of the melt.

4. The method as claimed in claim 3, wherein:
injecting the melt is performed by a first device.

5. The method as claimed in claim 3, wherein:
injecting the melt into the mold is performed while the mold is not fully closed, and so an embossing gap is formed in the mold, and
pressure is applied on the mold to close the mold until the embossing gap is eliminated.

6. A method for producing an encoder for bearing units, comprising the following steps:
introducing an insert part into a mold, wherein the insert part is a support part, a metal foil, or a metal-coated foil,
injecting a melt using a first device into the mold, wherein the melt includes a material which comprises polyamide 6, polyamide 12 or polyphenylene sulfide and at least one magnetic filler, and
compressing the melt, wherein the melt joins with the insert part to form the encoder on cooling of the melt.

7. (canceled)

8. (canceled)
